(19) United States
(12) Patent Application Publication
(10) Pub. No.: US 2016/0189151 A1
(43) Pub. Date: Jun. 30, 2016

(54) DISTRIBUTED AUTHENTICATION FOR MOBILE DEVICES

(71) Applicant: eBay Enterprise, Inc., King of Prussia, PA (US)

(72) Inventors: Robert He, Pflugerville, TX (US); Christopher Diebold O'Toole, Cedar Park, TX (US); Bryant Genepang Luk, Round Rock, TX (US); Eric Byungho Min, Austin, TX (US)

(21) Appl. No.: 14/587,649

(22) Filed: Dec. 31, 2014

(51) Int. Cl. G06Q 20/40; H04L 9/32

(52) U.S. Cl. CPC G06Q 20/401; H04L 9/3247; H04L 2209/24; H04L 2209/72; G06Q 2220/12

(57) ABSTRACT

An electronic commerce server connected to a network has access to user data, device data and public key data. The server receives transaction details including a digital signature from a mobile device, the digital signature generated using a first private key associated with a first public key. The server generates a challenge based on the transaction details and transmits the challenge to at least one computing device according to device data associated with the mobile device or user data associated with the user of the mobile device. The server may then receive a response to the challenge from the at least one computing device, the response including a digital signature generated using a second private key associated with a second public key. The server authorizes the transaction based on reading the first digital signature using the first public key and reading the second digital signature using the second public key.

### TECHNICAL FIELD

This application relates generally to implementing a requirement for a plurality of computing devices which communicate with a server to jointly authorize certain transaction at the server. In specific embodiments, systems and methods are described for authenticating a user for an electronic transaction based on receiving digital signatures generated by each of the plurality of computing devices using respective private keys stored by each of the plurality of computing devices.

### BACKGROUND

The ever-increasing use of mobile devices, such as an iPhone® (from Apple, Inc. of Cupertino, Calif.) or a device running Android™ (from Google, Inc. of Mountain View, Calif.), with data connections, ambient sensors and location determination capabilities, is slowly changing the way people interact, shop for products and services, and even manage financial accounts. In order to take advantage of these new possibilities, a user of a mobile device may download several applications (“apps”) onto the device that facilitate shopping, banking, accessing web based services or otherwise engaging in electronic transactions via a mobile device. However, as the amount and importance of such electronic transactions increase, so does the need for security.

Systems that provide electronic transaction functionality may rely on challenge-response authentication for security by having one party present information (“challenge”) and another party who must then provide a valid reply (“response”) in order to be authenticated for a transaction. One example of challenge-response authentication is password authentication, where the challenge is a request for a password and the valid response is the password. Cryptographic techniques may also be used with challenge-response authentication. For example, public-key cryptography may be used by requiring two separate “keys”, one of which is secret (or private) and one of which is public. The public and private keys are distinct but are mathematically linked. The public key may be used to verify information created with the private key. The public key may be shared (e.g., with electronic commerce websites) without compromising security, whereas the private key may be kept secret. In this way, user authentication may involve receiving a response to challenge wherein the response includes information (e.g., a digital signature) generated using a private key and verifying the information based on the corresponding public key.

### BRIEF DESCRIPTION OF THE DRAWINGS

Some embodiments are illustrated by way of example and not limitation in the figures of the accompanying drawings in which:

FIG. 1 is a block diagram depicting a system for enabling the authentication of a user for a transaction to be distributed among multiple computing devices, according to an example embodiment.

FIG. 2 is a block diagram illustrating an environment for authorizing a mobile device for a transaction, according to an example embodiment.

FIG. 3 is a block diagram illustrating the mobile device, as used according to an example embodiment.

FIG. 4 is a block diagram illustrating a network environment within which authentication of a user for a transaction is distributed among multiple computing devices, according to an example embodiment.

FIG. 5 is a block diagram illustrating authentication modules, according to an example embodiment.

FIG. 6 is a flowchart illustrating a method for authenticating of a user for a transaction using multiple computing devices, according to an example embodiment.

FIG. 7 is a flowchart illustrating a method of authenticating a user for a transaction based on responses received from multiple computing devices.

FIG. 8 is a diagrammatic representation of a machine in the example form of a computer system within which a set of instructions for causing the machine to perform any one or more of the methodologies discussed herein may be executed.

### DEFINITIONS

Location—For the purposes of this specification and the associated claims, the term “location” is used to refer to a geographic location, such as a longitude/latitude combination or a street address. The term “location” is also used within this specification in reference to a physical location associated with an event, such as a vacation destination or a bike path for riding a bicycle.

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

Context—For the purposes of this specification and the associated claims, the term “context” is used to refer to environmental inputs (e.g., sensor readings) such as location, time, and weather conditions, among others. The context generally refers to conditions describing an individual's (e.g., a user's) environment and/or activities. For example, context information may include a user's location, direction of movement, current weather conditions, time of day, and time of year (e.g., season), among other things. In the following examples, context may be used to determine if fragments of a private encryption key, distributed across a plurality of computing devices (e.g., smart phone), may be shared between the computing devices so that the complete private key may be formed based on the fragments. A mobile device may be permitted to access a fragment of the private key from another computing device based on the two computing devices operating in the same context, for example, being in the same location (e.g., within a specified distance from each other).

Device fingerprint—A device fingerprint (or machine fingerprint or browser fingerprint) is data collected about a remote computing device for the purpose of identifying said device. Fingerprints may be used to fully or partially identify individual users or devices by collecting, for example, basic web browser configuration information. However, collecting much more esoteric parameter data is possible and aggregating the collected data may comprise a device fingerprint as used and described herein.

### DETAILED DESCRIPTION

Example systems and methods for distributing authorization of a user for an electronic transaction across multiple computing devices are described, among other things. Also described are systems and methods for authenticating a user for an electronic transaction based on digital signatures generated using respective private encryption keys associated with respective public encryption keys. In some example embodiments, the systems and methods for authorizing the user are based on the multiple computing devices being located within a specified distance of each other. In the following description, for purposes of explanation, numerous specific details are set forth in order to provide a thorough understanding of example embodiments. It will be evident, however, to one skilled in the art, that the disclosed systems and methods may be practiced without these specific details. It will also be evident that distributing authorization of a user for an electronic transaction across multiple computing devices is not limited to the examples provided and may include other scenarios not specifically discussed.

It shall be understood that the disclosed systems and methods are addressed to processing (e.g., computing) device functionality including mobile processing devices. These mobile devices may include phones such as cellular phones (e.g., iPhone, BlackBerry, Android, Windows, etc.); tablets (e.g., iPad, Galaxy Tab, Kindle Fire, Surface, etc.); a wireless email device; personal digital assistants (PDAs); wearable processing devices (e.g., a smart watch), other devices capable of communicating wirelessly with a computer network or other communication network; or any other type of mobile device that may communicate over a network and handle electronic transactions. A mobile device may be a handheld device or a wearable device. Any mention or discussion herein of processing devices may also be applied to any other mobile devices as provided.

### Example System

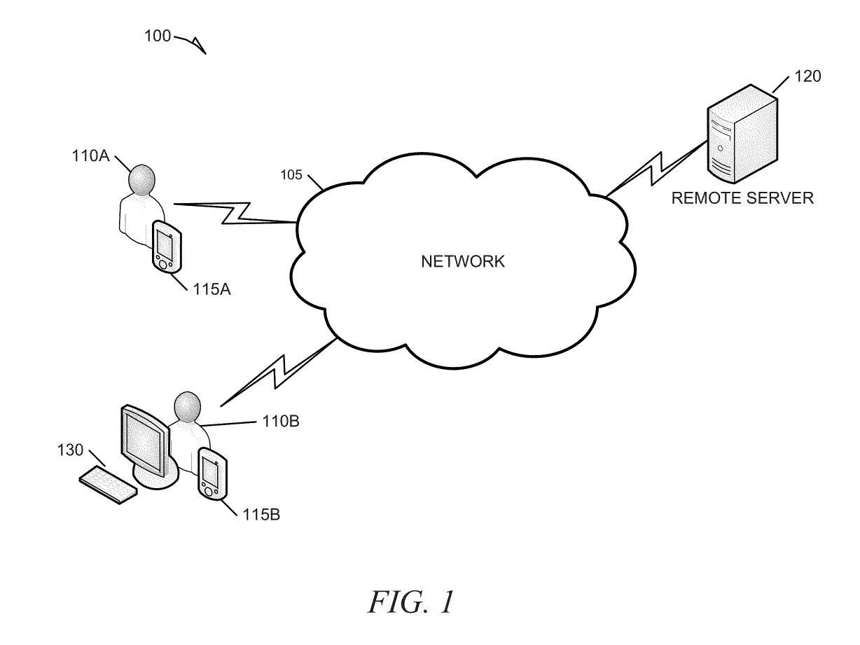

FIG. 1 is a block diagram depicting a system 100, according to an example embodiment, for enabling authentication of a user for an electronic transaction to be distributed among multiple computing devices that may each store a private key that may be used for electronic transactions. In an example, system 100 may include users 110A and 110B (collectively referred to as either user 110 or users 110 depending upon context), a network 105 (e.g., the internet) and a remote server 120 (e.g., an electronic commerce server). In an example, the user 110A may use mobile device 115A to connect to the remote server 120 via network 105. User 110B may use mobile device 115B or a more static computing device such as client 130 to connect to the remote server 120 via mobile device 115B or via network 105. In other examples, the private keys may be distributed across more than two users or more than two devices.

Since each of the computing devices (e.g., a mobile device 115 and/or client 130) stores a respective private key, each of the devices may be required to generate a digital signature (e.g., in response to a challenge from the server) before a single user (e.g., 110A) is authenticated for an electronic transaction (e.g., purchase) at the server 120. In an example, multiple users 110 may never need to communicate directly with each other to jointly authenticate one of the users 110 for an electronic transaction. The remote server 120 may be accessed by each user 110, such as user 110A, using mobile device 115A. For example, user 110A may initiate an electronic transaction at an e-commerce website hosted by the remote server 120. The remote server 120 may store public keys (or otherwise have access to public keys) corresponding to the private keys stored on the computing devices (e.g., 115 and/or 130). The public keys may also be associated with a specific software application of an electronic payment service, such as an digital wallet, and therefore a corresponding private encryption key would be used to make a payment with the payment service.

In an example, the mobile device 115A may generate a message proposing an electronic transaction, the message including relevant transaction details and a digital signature generated using the private key stored by mobile device 115A. Optionally, mobile device 115A may encrypt the message using the stored private key. The mobile device 115A may then send the message requesting the transaction (and including the relevant transaction details) to the remote server 120, for example, via a cash register device that forms part of network 105. The remote server 120 may read the digital signature using the public key that corresponds to the private key of mobile device 115A. The remote server 120 may also decrypt the message using the corresponding public key if the message from mobile device 115A has been encrypted using the private key of mobile device 115A. The remote server 120 may then attempt to authenticate the mobile device 115A (or user 110A) for the transaction by sending an authentication challenge to each of the other computing devices (e.g., 115 and/or 130) that is required to respond (with a proper digital signature) in order to authenticate the mobile device 115A (or user 110A) for the transaction. The remote server 120 may access profiles associated with user 110A or device 115A in order to determine which other user and/or devices must correctly respond to the authentication challenge in order to authenticate the mobile device 115A (or user 110A) for the transaction. The authentication challenge may optionally be encrypted using a public key corresponding to the private key stored at the other computing device so that the other computing device will have to decrypt the challenge using its private key before it may respond to the challenge.

In an example, at least one other computing device (e.g., 115 and/or 130) may receive the challenge issued by remote server 120 based on the at least one other computing device (e.g., mobile device 115B or client 130) being located within a specified distance of the mobile device 115A. For example, mobile device 115B may be a wearable computing device (e.g., watch or necklace). In this example, the mobile device 115B must be in the same location as the mobile device 115A (e.g., on the same person) in order to receive the challenge from the remote server 120. For example, the remote server 120 may forward the challenge (which may include information regarding the intended recipients of the challenge) to a cash register device (e.g., via the internet) and then the cash register device may determine if any of the intended recipients (e.g., mobile device 115A or mobile device 115B) are located nearby by sending out a signal via Bluetooth, localized Wi-Fi or something similar. In this way, if mobile device 115A were to be stolen, a thief could not use mobile device 115A for a purchase transaction at remote server 120 because the challenge responses required to authenticate mobile device 115A for the transaction could not be generated unless the thief also had access to wearable computing device 115B.

In another example, client 130 may be a stationary computing device (e.g., located within a merchant location) that stores a private key associated with mobile device 115A (or user 110A), and transaction authorization may require that the mobile device 115A be in the same location as the stationary client device 130 (e.g., within the merchant location) in order for client 130 to respond to an authentication challenge issued by remote sever 120. In this way, mobile device 115A might be authorized for certain transactions at the merchant location, but not be authorized elsewhere because authentication requires mobile device 115A to be in the same location as the stationary client device 130.

In another example, at least one authentication challenge response for authenticating mobile device 115A (and/or user 110A) for a transaction is received from a user 110B of another computing device (e.g., mobile device 115B or client 130) connected to remote server 120 via network 105 (e.g., the internet). For example, user 110B may receive an electronic message (e-mail, text, social media, etc.) including the authentication challenge (as well as other information such as transaction details) requesting that the user 110B affirmatively authorize (e.g., generate and transmit a response to the challenge) mobile device 115A. The message received by user 110B may include details of the transaction (amount, location, timestamp, etc.) to be authorized so that user 110B may decide whether to authorize mobile device 115A for the transaction.

In yet another example, the user 110A (using mobile device 115A) may transmit details of a transaction to the remote server 120 via mobile network 105 and, if the transaction meets certain criteria, require additional authorization in order to complete the transaction. For example, remote server 120 may require authorization involving additional devices and/or additional users in cases where the transaction exceeds a specified transaction limit associated with the mobile device 115A or user 110A (e.g., a pre-authorized purchase amount) In some examples, the transaction limit may be based on the context of the purchase, such as a limit relating to any of: a time of the transaction (e.g., daytime hours to prohibit “nightlife” spending), a location of the transaction (e.g., no bars or gambling establishments), a cost of the transaction (e.g., spending limit), or a category of the purchase transaction (e.g., no alcohol or junk food). The specified transaction limit may be associated with the mobile device 115A or the user 110A and may be applied by a remote server 120 based on, for example, a device fingerprint of mobile device 115A accessed by the remote server 120. The remote server 120 may compare this fingerprint to profiles associated with user 110A and/or mobile device 115A.

### Example Operating Environment

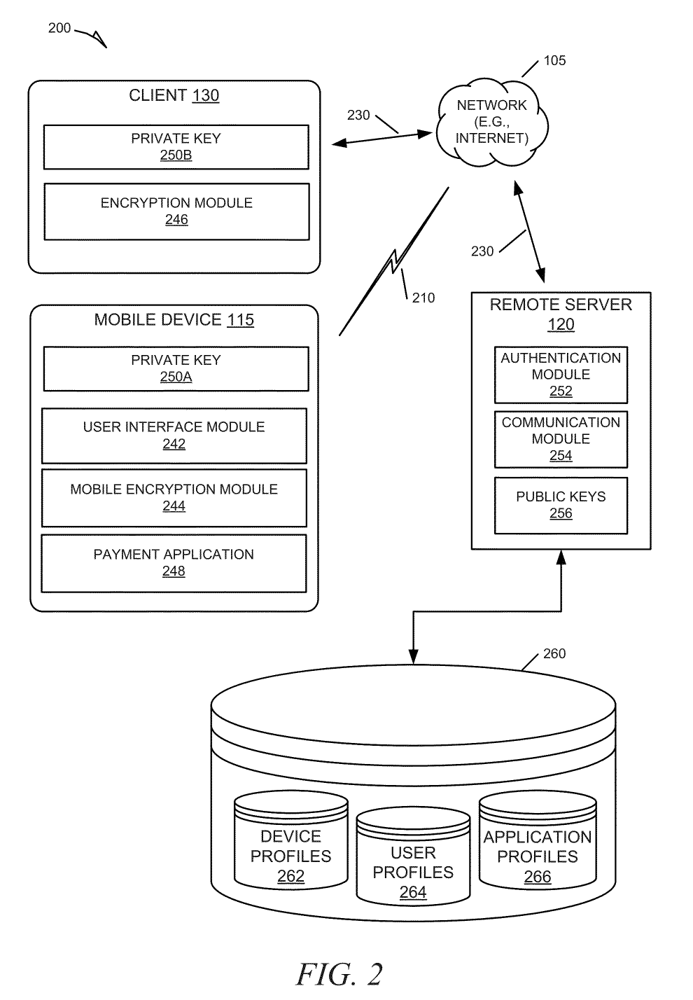

FIG. 2 is a block diagram illustrating an environment 200 for operating mobile devices 115 and/or clients 130 and a remote server 120, according to an example embodiment. The environment 200 is an example environment within which methods may be implemented for authenticating a single user (e.g., 110A) of a mobile device 115 for an electronic transaction via responses received at the remote server 120 from multiple computing devices (e.g., mobile devices 115 and/or clients 130) each storing a respective private key (250A, 250B, . . . ) corresponding to respective public keys of public keys 256 stored at remote server 120. The environment 200 may include a mobile device 115 storing a first private key 250A, wireless communication connections 210, a client 130 storing a second private key 250A, a network 105 (for example the internet), a communication connection 230, a remote server 120 storing public keys 256 corresponding to the private keys (e.g., 256A>250A, 256B>250B, . . . ), and a database 260. The mobile device 115 may include multiple modules and have multiple applications installed on it, including a user interface module 242, a mobile encryption module 244 and an electronic payment application 248 (e.g., PAYPAL payments smart phone application from PayPal, Inc. of San Jose Calif.), as well as others. The client device 130 may also include multiple modules and have multiple applications installed on it, including for example encryption module 244. The database 260 may optionally store the public keys 256, device profiles 262, user profiles 264, and/or application profiles 266. The mobile device 115 represents one example device (e.g., a cellular telephone, a Personal Digital Assistant (PDA), a Personal Navigation Device (PND), a handheld computer, a tablet computer, a notebook computer, or other type of movable device) that may be utilized by a user to run multiple software applications, such as electronic payment application 248.

The mobile device 115 may interface via connections 210 with the network 105 and the remote server 120, while the remote server 120 may interface via connection 230 with the network 105. The client 130 (e.g., a static computing device) may be coupled via a connection 230 to the network 105, for example, via wired or wireless interfaces. Of course, depending on the form of the mobile device 115, the client 130 and the remote server 120, any of a variety of types of connections 210 and 230 and networks 105 may be used. For example, the connections 210 and 230 may be Code Division Multiple Access (CDMA) connection, a Global System for Mobile communications (GSM) connection or other type of cellular connection. Such connections 210 and 230 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 105 may include a cellular network that has a plurality of cell sites of overlapping geographic coverage, interconnected by cellular telephone exchanges. These cellular telephone exchanges may be coupled to a network backbone (for example, a public switched telephone network (PSTN), a packet-switched data network, or other types of networks).

In another example, the connections 210 and 230 may be Wireless Fidelity (Wi-Fi, IEEE 802.11x type) connection, a Worldwide Interoperability for Microwave Access (WiMAX) connection, or another type of wireless data connection. In such an embodiment, the network 105 may include one or more wireless access points coupled to a local area network (LAN), a wide area network (WAN), the Internet, or other packet-switched data network.

In yet another example, the connections 210 and 230 may include a wired connection, for example an Ethernet link, and the communication network may be a LAN, a WAN, the Internet, or other packet-switched data network. Accordingly, a variety of different configurations are expressly contemplated.

The remote server 120 may be configured to provide various types of services (e.g., processing electronic transactions) to the mobile device 115. For example, one or more remote servers 120 may include a communication module 254 configured to interoperate with modules or applications executing on the mobile device 115 (e.g., payment application 248), to provide the ability for a user 110 of mobile device 115 to conduct electronic transactions at the remote server 120 using the mobile device 115. Furthermore, authentication module 252 of remote server 120 may use the stored public keys 256 (e.g., associated with the private keys of mobile device 115 and client 130), digital signatures received from mobile device 115 and client device 130 (generated using the private keys 250A and 250B), and/or knowledge of the context in which the mobile device 115 is operating to authorize electronic transactions requested via the mobile device 115 (e.g., by a user 110).

Since each of the computing devices (e.g., mobile device 115 and client 130) stores a respective private key (e.g., 250A and 250B), each device may generate a digital signature (via mobile encryption module 244 and encryption module 246) for transmission to remote server 120 using their respective private keys. The mobile device 115 may transmit a first digital signature to the remote server 120 together with the details of a proposed electronic transaction. Client 130 may receive an authentication challenge from remote server 120 (via communication module 254) via network 105, for example, using a local signal from a cash register at a merchant location and then transmit a response to the challenge including a generated second digital signature. The authentication challenge may optionally be encrypted using a public key 256 corresponding to the private key 250B stored at client 130 so that client 130 will have to decrypt the challenge using private key 250B before it may respond to the challenge. The mobile device 115 may then be authorized for the proposed transaction at remote server 120 based on the first and second digital signatures that are received from mobile device 115 and client 130 at remote server 120. Each of the devices (mobile device 115 and client 130) must provide digital signatures generated using private keys that correspond to one of the public keys 256 in order for a single mobile device 115 to be authenticated for the electronic transaction.

The remote server 120 may be accessed by mobile device 115 to request an electronic transaction, for examples at an e-commerce website hosted by the remote server 120. The public keys 256 which correspond to the private keys stored by mobile devices 115 and/or client devices 130 may also be associated with a specific payment application 248 of an electronic payment service (e.g., Google Wallet from Google, Inc. of Mountain View, Calif.) and therefore a response to an authentication challenge from server 120 would be needed to make a payment using the payment application 248. The remote server 120 may consult application profiles 266 in database 260 to determine if a public key of public keys 256 is associated with the payment application 248 from which a request for a transaction has been received at the remote server 120.

The mobile device 115 may generate a message requesting the electronic transaction (and including relevant transaction details) and may also generate a first digital signature using private key 250A. Mobile device 115 may also encrypt the message using the private key 250A. The mobile device 115 may then send the message (including the first digital signature) requesting the transaction to the remote server 120, for example via a cash register device forming part of network 105. An authentication module 252 of the remote server 120 may then (if necessary) decrypt the message using a first public key (of public keys 256) corresponding to private key 250A. If the message is able to be decrypted using the first public key, the authentication module 252 may then consult profiles (e.g., 262, 264 and 266) stored in database 260 in order to determine the requirements for authenticating mobile device 115 (or its user 110) for the transaction based on the relevant transaction details. The determination may be performed by the authentication module 252 based on a comparison of the relevant transaction details to device profiles 262, user profiles 264 and/or application profiles 266 in database 260. The device profiles 262, user profiles 264 and/or application profiles 266 may store information related to mobile device 115 or a user of the device 115 (e.g., user 110A), including which users or devices are required to authorize a transaction (e.g., which devices will be required to respond to an authentication challenge from remote server 120) using the mobile device 115 and what limits may be placed on transactions made with the mobile device 115 or by a user 110 of the mobile device 115 based on the context in which the transaction is requested.

The context in which mobile device 115 is operating may also determine whether the device may be authorized for a transaction by the remote server 120, for example, based on a second computing device (e.g., client 130) being located within a specified distance of the mobile device 115. In this case, the other computing device may be client 130 which may be a static computing device such as a point-of-sale terminal at a merchant location and the mobile device 115 may be required to be in the same location as the client 130 (e.g., in the merchant location) in order for the client 130 (which in some cases may store a private key 250B associated with mobile device 115 based on the user of mobile device 115 being a known patron of the merchant) to respond to an authentication challenge received from remote server 120. In this way, if the mobile device 115 were to be used for a purchase transaction at a merchant location for which the mobile device 115 is not authorized (e.g., a merchant that does not store a private key associated with the mobile device 115 or its user), the transaction would not be authorized by remote server 120 because the necessary responses to authentication challenges could not be provided in the absence of client device 130. In this way the mobile device 115 might be authorized for certain transactions at the merchant location, whereas similar transaction may not be authorized elsewhere.

In an embodiment, the copy of the private key 250B may be stored in a client 130 (associated with a user 110B) and connected to remote server 120 via network 105 (e.g., the internet). The private key 250B may be used to generate a second digital signature (e.g., using encryption module 246) in response to an authentication challenge from remote server 120 and the second digital signature may be used to authorize mobile device 115 for a transaction based on an explicit authorization (e.g., response to challenge) received from a user 110B of client 130 via network 105. The authorization may be requested from user 110B based on the devices (115 and 130) being too far apart to directly receive the authentication challenge via a local signal in the vicinity of mobile device 115. For example, user 110B may receive an electronic message from remote server 120 (e-mail, text, social media, etc.) including the authentication challenge requesting that user 110B respond to the challenge in order to authorize the transaction that mobile device 115 is attempting to complete. The message received by user 110B may include details of the transaction to be authorized so that user 110B may decide whether to explicitly authorize the transaction being attempted by the mobile device 115A.

In an embodiment, a user 110A may transmit details of a transaction to the remote server 120 via network 105 using mobile device 115, and the remote server 120 may determine if the transaction exceeds a specified transaction limit associated with the mobile device 115 or user 110A. If the transaction does exceed limits associated with the mobile device 115 or user 110A (e.g., based on profiles 262, 264 and 266) then the remote server 120 may require that appropriate responses to authentication challenges be received before the transaction being attempted by user 110A/mobile device 115 will be authorized. For example, a transaction limit may be based on the context of the transaction, such as a limit on any of: a time of the transaction (e.g., daytime hours to prohibit “nightlife” spending), a location of the transaction (e.g., no bars or gambling establishments), a cost of the transaction (e.g., spending limit), or a category of the transaction (e.g., no alcohol or junk food). The specified transaction limit may be associated with the mobile device 115 or the user 110A and may be applied by a remote server 120 based on, for example, a device fingerprint of mobile device 115A accessed by the remote server 120. The remote server 120 may compare this fingerprint to device profiles 262 or user profiles 264 in database 260.

### Example Mobile Device

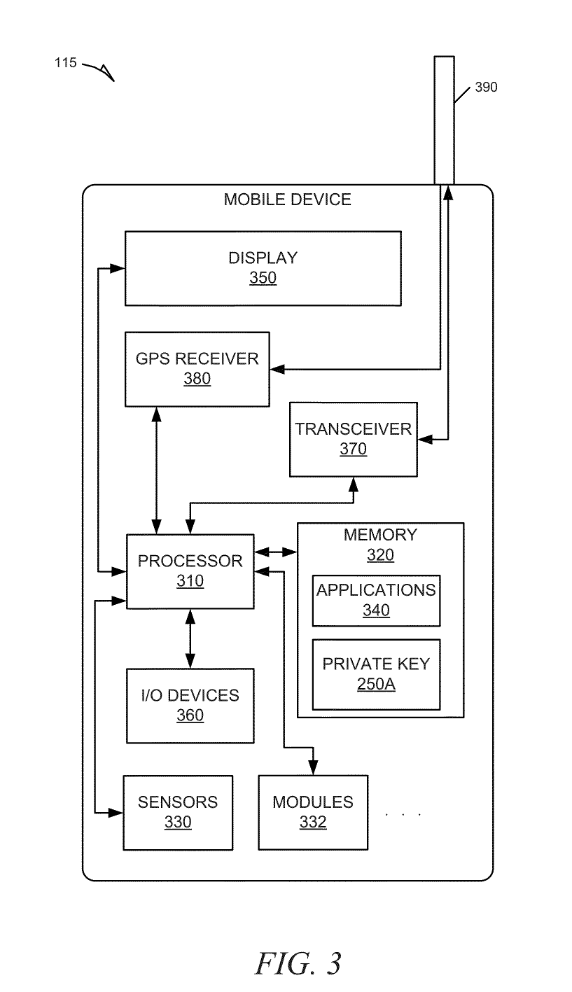

FIG. 3 is a block diagram illustrating an example mobile device 115, used according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor 310. The memory 320 may be adapted to store a private key 250A, an operating system, as well as application programs 340, such as the payment application 248 of the mobile device 115 shown in FIG. 2. In certain examples, the application programs 340 may include applications that retrieve information from the mobile device 115, such as a location determination application for determining a location (e.g. street, city, state, etc.) of the mobile device 115. For example, the location determination application may use data from of a GPS receiver 380 for this purpose. In other examples, a proximity determination application may use data from one of several sensors 330 incorporated into mobile device 115 to determine if mobile device 115 is within a specified distance from another computing device storing a fragment of the private encryption key (e.g., client 130 storing private key 250B). The sensors in mobile device 115 (e.g., sensors 330) may provide sensor readings including any combination of the following: time, temperature, pressure, humidity, orientation, velocity, acceleration, compass bearing, and volume, which may be used to establish the context in which mobile device 115 is operating.

The processor 310 may be coupled, either directly or via appropriate intermediary hardware, to modules 332 (e.g., modules 242 and 244 of FIG. 2) a display 350, and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the network 105 and/or other computing device (e.g., client 130) may be established. Furthermore, in some configurations, GPS receiver 380 may also make use of the antenna 390 to receive GPS signals.

### Example Platform Architecture

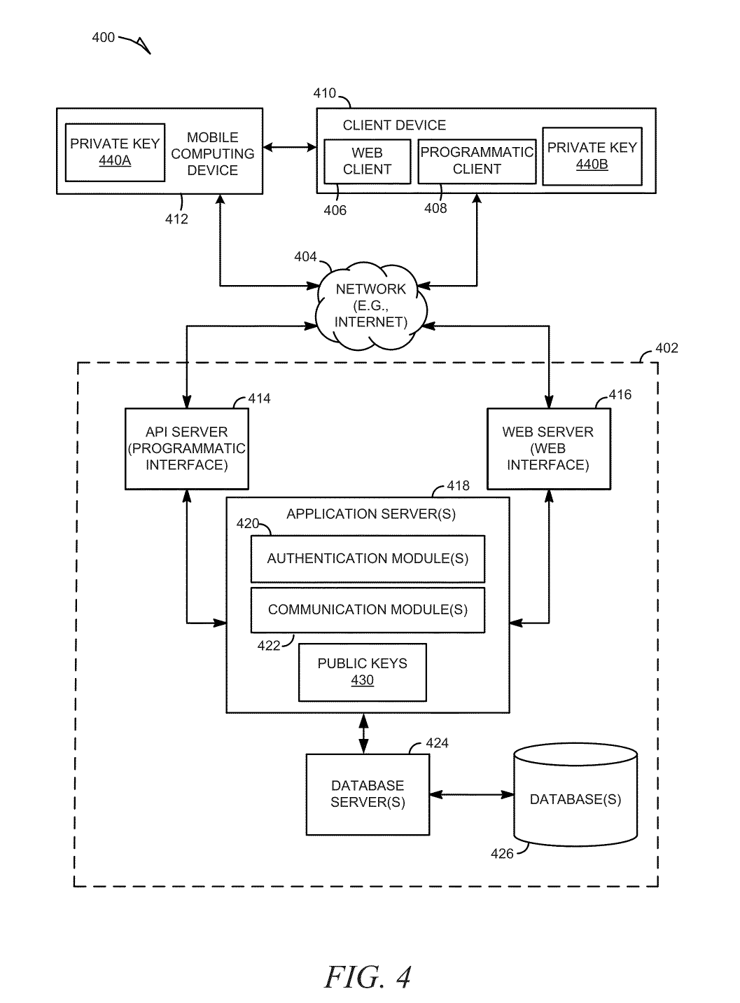

FIG. 4 is a block diagram illustrating a network environment 400 within which a single user (e.g., 110A) of a mobile device 412 may be authenticated for an electronic transaction via digital signatures received at application server(s) 418. The digital signatures may be received from multiple computing devices (e.g., client machine 410) that each store a copy of a respective private key (copies 440A, 440B, . . . ) corresponding to one of the public keys 430 stored at the application server(s) 418. The block diagram depicts a network environment 400 (in the exemplary form of a client-server system), within which example embodiments may be deployed. A networked system 402 is shown, in the example form of a network-based and server-mediated communication system, that provides server-side functionality, via a network 404 (e.g., the Internet or WAN) to client machine 410 (storing a private key 440B) and mobile device 412 (storing a copy of the private key 440A). The client machine 410 may include a web client 406 (e.g., a browser, such as the Internet Explorer browser developed by Microsoft Corporation of Redmond, Wash. State) and a programmatic client 408 (e.g., PAYPAL payments smart phone application from PayPal, Inc. of San Jose, Calif.) executing on the client machine 410. In certain examples, the client machine 410 may be in the form of a mobile device or a stationary computing device. In an example, the programmatic client 408 may be the RedLaser mobile shopping application from eBay, Inc. of San Jose, Calif. The mobile device 412 may also use a web client or a programmatic client.

An Application Programming Interface (API) server 414 and a web server 416 are coupled to, and provide programmatic and web interfaces respectively to, one or more application servers 418. The application server(s) 418 stores public keys 430 (corresponding to the private keys 440A and 440B) and also hosts one or more authentication modules 420 (in certain examples, these may also include decryption modules, matching modules, and a rules engine, to name a few) and communication module(s) 422. The application server(s) 418 is, in turn, coupled to one or more database servers 424 that facilitate access to one or more databases 426. In some examples, the application server(s) 418 may access the database(s) 426 directly without the need for a database server(s) 424.

The authentication module(s) 420 may provide a number of security functions and services to users that access the networked system 402, allowing them to process electronic transactions at the application server(s) 418 via, for example, mobile device 412 interacting with a merchant cash register device that forms part of network 404. Furthermore, authentication module(s) 420 may use the stored public keys 430, digital signatures received from mobile device 412 and client device 410 (generated using the private keys 440A and 440B), and/or knowledge of the context in which the mobile device 412 is operating to authorize and facilitate electronic transactions requested via the mobile device 412 (e.g., by a user 110). The communication module(s) 422 may likewise provide a number of communication services and functions to users. For example, the communication module(s) 422 may forward authentication challenges to computing devices (e.g., client device 410) required to respond in order for mobile device 412 to be authorized for a particular transaction or allow a user of client machine 410 to authorize an electronic transaction requested by mobile device 412, such as a purchase transaction, by sending an authorization message (e.g., including a response to an issued authentication challenge) to the application server(s) 418 over network 404. The authentication challenge may optionally be encrypted using a public key 430 corresponding to the private key 440 stored at client device 410 so that client device 410 will have to decrypt the challenge using private key 440B before it may respond to the challenge. The communication module(s) 422 may also be configured to facilitate communication between applications (e.g., payment application 248) that may be running on client machine 410 or mobile device 412 and the application server(s) 418.

Furthermore, while the network environment 400 shown in FIG. 4 employs client-server architecture, the example systems are of course not limited to such an architecture, and could equally well find application in a distributed, or peer-to-peer, architecture system, for example. The various authentication module(s) 420 and communication module(s) 422 may also be implemented as standalone systems or software programs, which do not necessarily have networking capabilities.

The web client 406 may access the various authentication module(s) 420 and communication module(s) 422 via the web interface supported by the web server 416. Similarly, the programmatic client 408 accesses the various services and functions provided by the authentication module(s) 420 and communication module(s) 422 via the programmatic interface provided by the API server 414. The programmatic client 408 may, for example, be a smart phone application (e.g., the PAYPAL payments application) that enables users to process payments directly from their smart phones leveraging user profile data and current location information provided by the smart phone or accessed over the network 404.

The mobile device 412 may be used to input details of a purchase transaction at the application server(s) 418. The application server(s) 418 may not be required to authorize the purchase via authentication module(s) 420 unless limits to the transactions made with mobile device 412 are being enforced by the application server(s) 418. These limits—for example, a purchase transaction beyond a specified purchase transaction limit associated with the mobile device 412 or the user of the device 412—may be accessed by the authentication module(s) 420 via the database(s) 426 and/or database server(s) 424. The database(s) 426 and/or database server(s) 424 may also store or a list of associated computing devices (and/or their users) that must respond to an authentication challenge in order for the mobile device 412 to be authorized for a transaction beyond the transaction limits associated the mobile device 412. In an example, if the required responses to authentication challenges are received at the application server(s) 418, a transaction using mobile device 412 may be authorized in spite of any limits that may otherwise be enforced by the application server(s) 418. Therefore, unless all of the required responses are provided by the associated computing devices certain limits may be applied to purchase transactions requested using the mobile device 412.

For example, mobile device 412 may generate a message requesting the electronic transaction and including the relevant transaction details. The mobile device 412 may also generate a first digital signature using the private key 440A. The mobile device 412 may then send the message (including the first digital signature) requesting the transaction to the application server(s) 418, for example via a cash register device forming part of network 404. The mobile device 412 may also encrypt the message using private key 440A. An authentication module 420 of the application server(s) 418 may then (if necessary) decrypt the message using a first public key (of public keys 430) corresponding to private key 440A. The authentication module 420 may then consult database(s) 426 and/or database server(s) 424 in order to determine the requirements for authenticating mobile device 412 (or its user 110) for the transaction based on the relevant transaction details. The determination may be performed by the authentication module 252 based on a comparison of the relevant transaction details to user and device data associated with mobile device 412 in database(s) 426 and/or database server(s) 424. The user and device data (e.g., device profiles 262, user profiles 264 and/or application profiles 266) may include information related to mobile device 412 or a user of the device 412 (e.g., user 110A), including which users or devices are required to authorize a transaction using the mobile device 412 (e.g., which devices will be required to respond to an authentication challenge from application server(s) 418) and what limits may be placed on transactions made with the mobile device 412 or by a user 110 of the mobile device 412 based on the context in which the transaction is requested.

The context in which mobile device 412 is operating may also determine whether the device may be authorized for a transaction by the application server(s) 418, for example, based on a second computing device (e.g., client device 410) being located within a specified distance of the mobile device 412. In this case, the other computing device is client device 410 which may be a static computing device or another mobile device such as mobile device 412. Authentication may in some cases require that the mobile device 412 be in the same location as the client device 410 (e.g., within a specified distance from each other) in order for the client device 410 (which stores private key 440B) to respond to an authentication challenge (e.g., with a second digital signature) received from application server(s) 418. In this way, a thief could not use a stolen mobile device 412 for a purchase transaction unless the thief also had access to client device 410 because transmission of the necessary responses to authentication challenges require mobile device 412 and client device 410 to be near each other.

In an embodiment, the private key 440B may be stored in a client device 410 (e.g., associated with a user 110B) and connected to application server(s) 418 via network 404 (e.g., the internet). The private key 440B may be used to generate a response to an authentication challenge from application server(s) 418 and the response may be used to authorize mobile device 412 for a transaction based on an explicit authorization received from a user 110B of client device 410 via network 404. The authorization may be requested from user 110B based on the devices (410 and 412) being too far apart (e.g., beyond specified limit) to directly receive the authentication challenge via a local signal in the vicinity of mobile device 412. For example, user 110B may receive an electronic message from application server(s) 418 (e-mail, text, social media, etc.) including the authentication challenge and requesting that user 110B respond to the challenge in order to authorize the transaction that is being attempted using mobile device 412. The message received by user 110B may include details of the transaction to be authorized so that user 110B may decide whether to authorize the transaction that is being attempted with the mobile device 412.

In an embodiment, a user 110A may transmit details of a transaction to the application server(s) 418 via network 404 using mobile device 412, and the application server(s) 418 may determine if the transaction exceeds a specified transaction limit associated with the mobile device 412 or user 110A. If the transaction does exceed any limits associated with the mobile device 115 or user 110A (e.g., based on user and/or device data in database(s) 426) then the application server(s) 418 will require that appropriate responses to authentication challenges be received before the transaction (exceeding certain limits) will be authorized for the user 110A to perform with mobile device 412. The specified transaction limit may be associated with the mobile device 412 or the user 110A and may be applied by application server(s) 418 based on, for example, a device fingerprint of mobile device 412 accessed by the application server(s) 418. The application server(s) 418 may compare this fingerprint to device profiles 262 or user profiles 264 in database 260. The application server(s) 418 may compare this fingerprint to user and/or device data in database(s) 426 and/or database server(s) 424.

### Example Authentication Modules

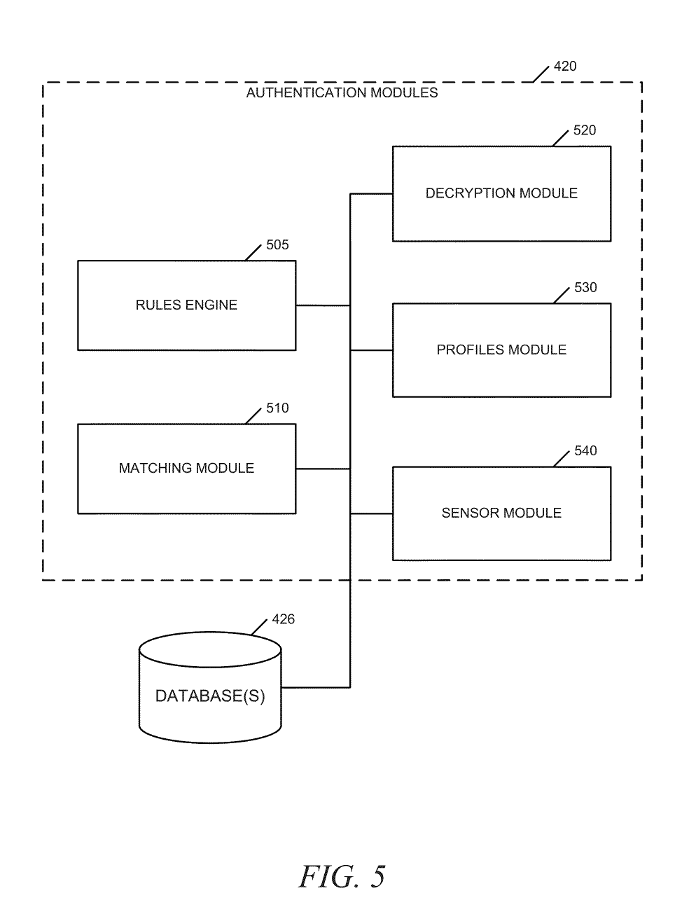

FIG. 5 is a block diagram illustrating authentication modules 420, according to an example embodiment. In this example, the authentication modules 420 may include a rules engine 505, a matching module 510, a decryption module 520, a profiles module 530, and a sensor module 540, among others. In an example, the authentication modules 420 may access database(s) 426 to store and/or retrieve decryption rules, user profile data, application profile data, device profile data, and public keys 430, as well as other information, to enable authentication of users or devices and authorization of said users or devices for electronic transactions.

In an example, the rules engine 505 may be configured to manage and evaluate rules controlling how one or more applications (e.g., payment application 248 running on mobile device 115 or client 130) may be permitted to access and communicate with the application server(s) 418 hosting the authentication module(s) 420. For example, the rules engine 505 may include rules regarding contextual situations like time of day, time of the year, location, etc. In an example, the rules engine 505 may include user identification rules (e.g., a unique device fingerprint) and/or context identification rules (e.g., a user must be located within a location supported by the application server(s) 418).

The matching module 510 may be configured to monitor all communications involving the authentication module(s) 420 and determine which communications have been received from the same physical hardware processing device or from the same user. In an example, the matching module 510 may be configured to match processing device fingerprints received from applications running on mobile device 412 or client device 410. In an example, the processing device fingerprint may include any combination of a: country code, device brand, device model, device carrier, IP address, language, OS name, OS version, and timestamp; and the matching module 510 may be configured to match these device fingerprints to a pre-established degree of certainty.

In an example, the matching module 510 may be configured to match processing device sensor readings received from applications running on mobile device 412 or client device 410. In an example, the processing device sensor readings may include any combination of a: time, temperature, pressure, humidity, orientation, velocity, acceleration, compass bearing, volume, latitude and longitude; and the matching module 510 may be configured to match these sensor readings to a pre-established degree of certainty.

In an example, the decryption module 520 is configured to decrypt encrypted messages that have been received from the applications running on mobile device 412 or client device 410 (e.g., encrypted using the respective private keys 440A and 440B) based on corresponding public keys 430. The private keys (e.g., 440A) and the corresponding public keys 430 may be associated with the mobile device 412 (or client device 410), a user of the mobile device 412 (or of client device 410) and/or a specific application running on mobile device 412. The decryption module 520 may, for example, interface with the rules engine 505, the profiles module 530 and/or the database(s) 426 in performing its functions, as explained in more detail below.

In an example, the profiles module 530 is configured to provision (e.g., set up) and manage several profiles within database(s) 426 and also access and cross-reference these profiles when needed. For example, if a transaction request message received by the application server(s) 418 includes a unique device fingerprint that may be used to uniquely identify the context in which the mobile device 412 from which it is received is operating in, this fingerprint (or other information used to identify the application, device, or user) may be cross-referenced with data from profiles (like application profiles 266 in database 260 of FIG. 2) in database(s) 426. Alternatively or additionally it may be used to update the respective profiles in database(s) 426.

In an example, the sensor module 540 is configured to record the sensor data received from applications running on a mobile device 412 or client device 410. In an example, the sensor module 540 may also store and manage sensor data within database(s) 426 and also access and cross-reference this data when needed. For example, if a transaction request message received by the application server(s) 418 includes a time, temperature, pressure, humidity, orientation, velocity, acceleration, compass bearing, volume, latitude and longitude, this data (or other sensor data) may be cross-referenced with the sensor data from the database(s) 426. Alternatively or additionally it may be used to update any corresponding sensor data in database(s) 426.

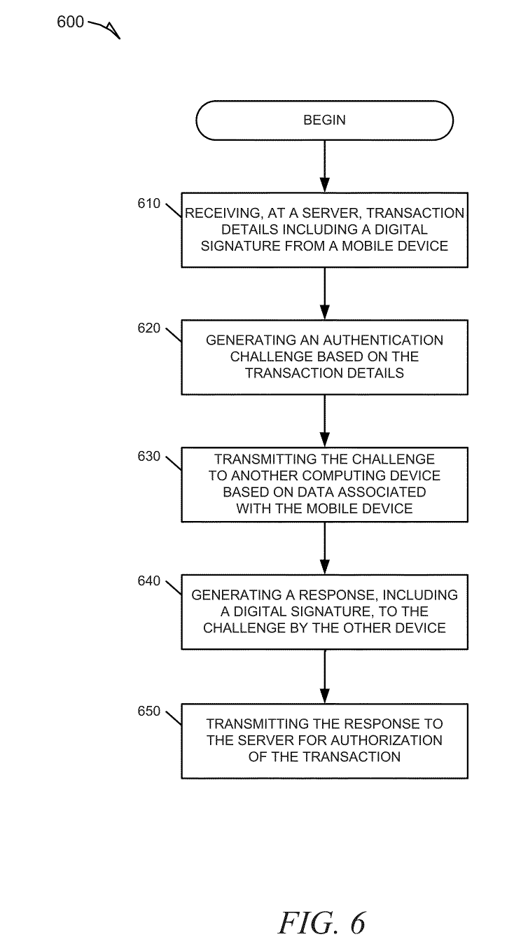

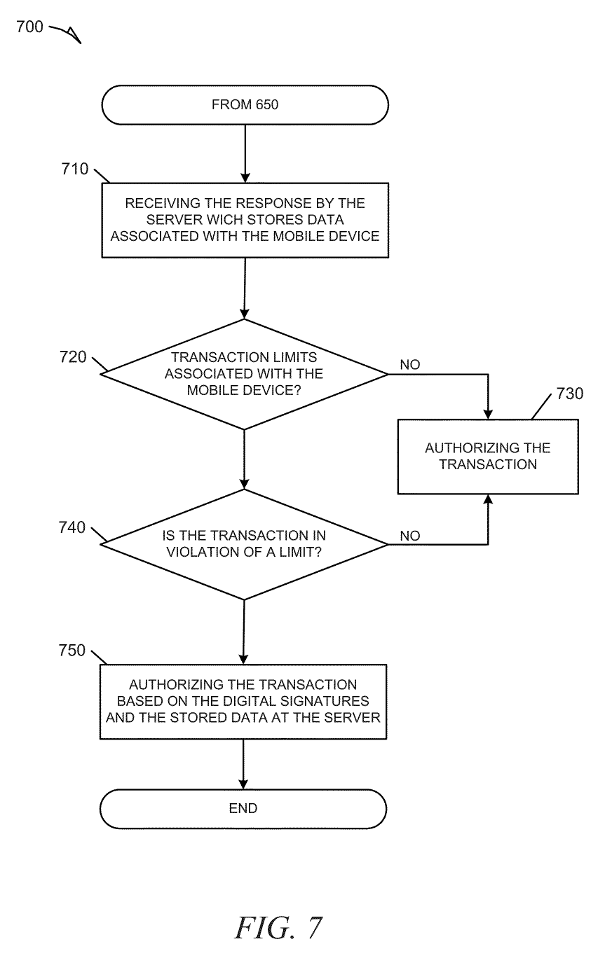

Additional details regarding the functionality provided by the authentication module(s) 420 are detailed in reference to FIGS. 6-7 below.

### Example Methods

Example methods will be described below; in particular the methods will be described in relation to the previously described figures and elements.

FIG. 6 is a flowchart illustrating a method 600 for authenticating of a user for a transaction using multiple computing devices, according to an example embodiment. In an example, the method 600 may include operations for: receiving transaction details including a digital signature at operation 610, generating an authentication challenge based on the transaction details at operation 620, transmitting the authentication challenge to another computing device at operation 630, generating a response to the challenge by the other computing device at operation 640, and transmitting the response to the server at operation 650.

The method 600 may begin at operation 610 with the commerce server (e.g., remote server 120 storing public keys 256) receiving data from an application (e.g., payment application 248) running on the mobile device (e.g., mobile device 115 storing private key 250A corresponding to a first public key of public keys 256) connected to a network, e.g., network 105. In certain examples, the data received from the application includes relevant transaction details, information for uniquely identifying the context in which the mobile device is operating and a first digital signature generated using a first private key corresponding to a first public key at the server. For example, the data received from the application may contain location data for mobile device which may be compared to location data from other computing devices to determine if the computing devices are close enough to each other, e.g., within a specified distance. At operation 620, the method 600 may continue with the commerce server generating an authentication challenge based on the received transaction details. At operation 630, the method 600 may continue with the commerce server transmitting the authentication challenge to another computing device (e.g., client 130 storing password copy 250B corresponding to password data 256) before authorizing the transaction. The server may determine where to send the challenge (e.g., possibly to multiple other computing devices) based on stored data (e.g., stored at database 260) associated with the mobile device or its user. At step 640, the method 600 may continue with the other computing device generating a response (e.g., using encryption module 246) to the received authentication challenge including a second digital signature generated using a second private key (e.g., 250B) corresponding to a second pubic key of the public keys 256. Finally, at step 650, the method 600 may include the other computing device transmitting the generated response (possibly encrypted using the second private key) to the commerce server for authorization and processing of the requested transaction.

FIG. 7 is a flowchart illustrating a method of authenticating a user for an electronic transaction based on responses received from multiple computing devices. The method 700 may continue from operation 650 (of FIG. 6) and include steps for: receiving the response by the commerce server that stores the public keys at operation 710, determining whether any limits to the transactions requested by the mobile device are being enforced at operation 720 and authorizing the transaction at operation 730 if there are no such limits, determining whether the transaction requested by the mobile device is in violation of a limit at operation 740, authorizing the transaction at operation 730 if there is no such violation, and authorizing the transaction based on the received authentication challenge responses and the password data at operation 750 if there is a limit in regard to which the requested transaction is in violation.

The method 700 may begin at operation 710 (continuing from operation 650 of FIG. 6) with the networked system 402 (which stores public keys 430 corresponding to the private keys stored by mobile device 412 and client device 410) receiving the authentication challenge response from the other computing device. At operation 720, the method 700 may continue with networked system 402 determining whether any limits should be applied to a transaction requested by mobile device 412. This may be accomplished by consulting a device profile (associated with mobile device 412) in database(s) 426 or a user profile (associated with a user of mobile device 412) in database(s) 426. If there are no such limits, the method 700 may proceed to operation 730, where the transaction is authorized by networked system 402. If there are such limits, the method 700 may proceed to operation 740.

At operation 740, the method 700 may continue with networked system 402 comparing context information (including transaction details, sensor readings and/or location readings, etc.) received from the application running on mobile device 412 to specific limits associated with mobile device 412 (or a user of the device 412) to determine if the requested transaction is in violation of one of the limits. If there are no such violations of a limit, the method 700 may proceed to operation 730, where the transaction is authorized by networked system 402. If there are such limits, the method 700 may proceed to operation 750.

At operation 750, the networked system 402 may authorize the requested transaction (beyond the limit which the transaction would violate) based on authenticating (and decrypting if needed) the digital signature received from the mobile device and the authentication challenge response from the other computing device using the stored public keys 430.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of these. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry (e.g., a FPGA or an ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures deployed, in example embodiments.

### Example Architecture and Machine-Readable Medium

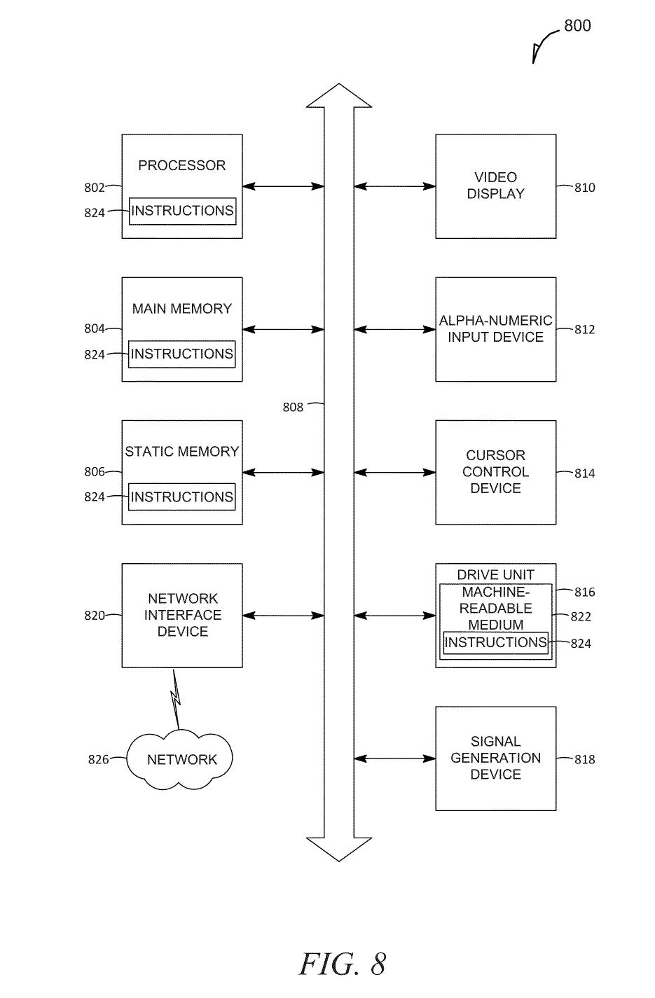

FIG. 8 is a block diagram of a machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal displays (LCD) or a cathode ray tube (CRT)). The computer system 800 also includes an alphanumeric input device 812 (e.g., a keyboard), a cursor control (user interface (UI) navigation) device 814 (e.g., a mouse), a disk drive unit 816, a signal generation device 818 (e.g., a speaker) and a network interface device 820.

### Machine-Readable Medium

The disk drive unit 816 includes a machine-readable medium 822 on which is stored one or more sets of data structures and instructions 824 (e.g., software) embodying or used by any one or more of the methodologies or functions described herein. The instructions 824 may also reside, completely or at least partially, within the main memory 804, static memory 806, and/or within the processor 802 during execution thereof by the computer system 800, with the main memory 804 and the processor 802 also constituting machine-readable media.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions 824 for execution by the machine and that cause the machine to perform any one or more of the methodologies disclosed herein, or that is capable of storing, encoding or carrying data structures used by or associated with such instructions. The term “machine-readable medium” shall accordingly be taken to include, but not be limited to, solid-state memories and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions 824 for execution by the machine, and includes digital or analog communications signals or other intangible media to facilitate communication of such software.

Thus, a method and system for sharing fragments of a private encryption key between multiple computing devices has been described. Although the present disclosure includes references to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure covers any and all adaptations or variations of various embodiments. Combinations of the above embodiments, and other embodiments not specifically described, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A system comprising:
an electronic commerce server connected to a network and including:
a storage medium storing user profiles, device profiles and public keys; and
a communication module configured to:
receive transaction details including a first digital signature from a mobile device storing a first private key associated with a first public key;
generate a challenge based on the transaction details;
transmit, according to a device profile of the mobile device or a user profile of a user of the mobile device, the challenge to at least one computing device storing a second private key associated with a second public key; and
receive a response to the challenge from the at least one computing device, the response including a second digital signature; and
an authentication module configured to authorize the transaction based on the first digital signature, the first public key, the second digital signature and the second public key.

2. The system of claim 1, wherein:
the mobile device includes a mobile encryption module configured to generate the first digital signature using the first private key; and
the at least one computing device includes an encryption module configured to generate the second digital signature using the second private key.

3. The system of claim 2, wherein:
the mobile encryption module is configured to encrypt the transaction details using the first private key;
the encryption module is configured to encrypt the response using the second private key; and
the authentication module is configured to decrypt the transaction details using the first public key and to decrypt the response using the second public key.

4. The system of claim 1, wherein:
the communication module is further configured to transmit the challenge to the at least one computing device based on the at least one computing device being located within a specified distance of the mobile device; and
the at least one computing device is configured to transmit the response to the challenge based on being located within the specified distance of the mobile device.

5. The system of claim 4, wherein the communication module is further configured to request a response to the challenge from a user of the at least one computing device based on the at least one computing device not being located within the specified distance of the mobile device.

6. The system of claim 2, wherein:
the authentication module is further configured to encrypt the challenge using the second public key; and
the encryption module is configured to decrypt the challenge using the second private key.

7. The system of claim 1, wherein:
the authentication module is further configured to authorize a transaction beyond a specified transaction limit indicated by the device profile of the mobile device or the user profile of the user of the mobile device; and
the transaction limit is for limiting at least one of: a time of the transaction, a location of the transaction, a cost of the transaction, or a category of the transaction.

8. A method comprising:
receiving, at a server, transaction details including a digital signature from a mobile device, the digital signature generated using a first private key associated with a first public key;
generating a challenge based on the transaction details;
transmitting the challenge to at least one computing device according to device data associated with the mobile device or user data associated with the user of the mobile device;
receiving a response to the challenge from the at least one computing device, the response including a digital signature generated using a second private key associated with a second public key; and
authorizing the transaction based on the first digital signature, the first public key, the second digital signature and the second public key.

9. The method of claim 8, further comprising:
encrypting, by the mobile device, the transaction details using the first private key;
encrypting, by the at least one computing device, the response using the second private key;
decrypting, by the server, the encrypted transaction details using the first public key and the response using the second public key.

10. The method of claim 8, further comprising:
transmitting the challenge to the at least one computing device based on the at least one computing device being located within a specified distance of the mobile device; and
transmitting the response to the server based on the at least one computing device being located within the specified distance of the mobile device.

11. The method of claim 10, further comprising:
requesting a response to the challenge from a user of the at least one computing device based on the at least one computing device not being located within the specified distance of the mobile device.

12. The method of claim 8, further comprising:
encrypting the challenge, by the server, using the second public key; and
decrypting the challenge, by the at least one computing device using the second private key.

13. The method of claim 8, further comprising authorizing a transaction beyond a specified transaction limit associated with the mobile device or the user of the mobile device.

14. The method of claim 13, wherein the transaction limit is for limiting at least one of: a time of the purchase transaction, a location of the transaction, a cost of the transaction, or a category of the transaction.

15. A non-transitory machine-readable storage device storing a set of instructions which, in response to execution by processors of machines, cause the machines to perform operations comprising:
receiving transaction details including a digital signature from a mobile device, the digital signature generated using a first private key associated with a first public key;
generating a challenge based on the transaction details;
transmitting the challenge to at least one computing device according to device data associated with the mobile device or user data associated with the user of the mobile device;
receiving a response to the challenge from the at least one computing device, the response including a digital signature generated using a second private key associated with a second public key; and
authorizing the transaction based on the first digital signature, the first public key, the second digital signature and the second public key.

16. The machine-readable storage device of claim 15, the operations further comprising:
encrypting, by the mobile device, the transaction details using the first private key;
encrypting, by the at least one computing device, the response using the second private key;
decrypting the encrypted transaction details using the first public key and the response using the second public key.

17. The machine-readable storage device of claim 15, the operations further comprising:
transmitting the challenge to the at least one computing device based on the at least one computing device being located within a specified distance of the mobile device; and
transmitting the response based on the at least one computing device being located within the specified distance of the mobile device.

18. The machine-readable storage device of claim 17, the operations further comprising:
requesting a response to the challenge from a user of the at least one computing device based on the at least one computing device not being located within the specified distance of the mobile device.

19. The machine-readable storage device of claim 15, the operations further comprising authorizing a transaction beyond a specified transaction limit associated with the mobile device or the user of the mobile device.

20. The machine-readable storage device of claim 19, wherein the transaction limit is for limiting at least one of: a time of the transaction, a location of the transaction, a cost of the transaction, or a category of the transaction.
